(19) United States
(12) Patent Application Publication
(10) Pub. No.: US 2017/0307392 A1
(43) Pub. Date: Oct. 26, 2017

(54) ROUTE SEARCHING DEVICE FOR RECHARGEABLE VEHICLE, ROUTE SEARCHING METHOD FOR RECHARGEABLE VEHICLE, AND PROGRAM

(71) Applicant: MITSUBISHI HEAVY INDUSTRIES, LTD., Tokyo (JP)

(72) Inventors: Kazuyoshi KITAJIMA, Tokyo (JP); Takashi SAITO, Tokyo (JP)

(21) Appl. No.: 15/649,606

(22) Filed: Jul. 13, 2017

Related U.S. Application Data
(63) Continuation of application No. 15/035,889, filed on May 11, 2016.

(30) Foreign Application Priority Data
Nov. 13, 2013 (JP) 2013-235125

(51) Int. Cl. G01C 21/34; G01C 21/36; B60L 11/18

(52) U.S. Cl. CPC G01C 21/3469; B60L 11/1848; B60L 11/1861; G01C 21/362; B60L 11/1846; G01C 21/3415; Y02T 90/14; Y02T 90/128; Y02T 90/121; Y02T 10/7291; Y02T 10/7088; Y02T 10/705; Y02T 10/7044; Y02T 10/7005; B60L 2260/58; B60L 2260/54; B60L 2260/52; B60L 2240/72; B60L 2230/40; Y02T 90/161; Y02T 90/163; Y02T 90/168; Y02T 90/169; Y04S 30/14; Y04S 30/12

(57) ABSTRACT

A route searching device for a rechargeable vehicle includes an acquisition unit and a movement plan creation unit. The acquisition unit acquires facility information regarding a use state of a supply facility which includes at least one of vehicle supply facilities which supplies a rechargeable vehicle, and a charging facility which supplies power to a battery of the rechargeable vehicle. The movement plan creation unit creates a movement plan based on map information and the facility information. The movement plan includes a route to a destination, which includes the supply facility to be used, and supply details received by the supply facility on the route.

### CROSS-REFERENCE TO RELATED APPLICATION

The present application is a continuation of U.S. patent application Ser. No. 15/035,889 filed on May 11, 2016, which is a National Phase of International Application Number PCT/JP2014/079852, filed Nov. 11, 2014, which claims priority to Japanese Application Number 2013-235125, filed Nov. 13, 2013. The disclosures of all of the above-listed prior-filed applications are hereby incorporated by reference herein in their entirety.

### TECHNICAL FIELD

The present invention relates to a route searching device for a rechargeable vehicle, a route searching method for a rechargeable vehicle, and a program.

Priority is claimed on Japanese Patent Application No. 2013-235125, filed Nov. 13, 2013, the content of which is incorporated herein by reference.

### BACKGROUND ART

Recently, a car sharing system in which a plurality of people commonly uses a shared car for car sharing has been widely used. Regarding the car sharing system, a service using a rechargeable vehicle as the shared car has attracted attention. Because the rechargeable vehicle requires a long time for charging, in order to reduce traveling time to a destination, a shared car having a state of charge which allows traveling to the next point is required at a boarding point, or at a transfer point, when traveling is started. In a case where a charging station is used in the middle of traveling, an available charger is required to be ensured as a facility of a charging point.

For example, if a request for a boarding point and a destination is received from a user, vehicles having a state of charge which allows arrival in a charging station closest to the destination on a route through the boarding point and the destination from the current position of a vehicle being moving are extracted. Among the extracted vehicles, a vehicle closest to the boarding point of the user is notified of a vehicle dispatch instruction (for example, see PTL 1).

### CITATION LIST

### Patent Literature

[PTL 1] Japanese Unexamined Patent Application, First Publication No. 2012-73979

### SUMMARY OF INVENTION

### Technical Problem

In a car sharing system, the number of shared cars which have to be ensured in a facility providing the shared car and are being used, the state of charge of each of the shared cars, or availability of a charger at a charging station is ever-changing in accordance with a use state thereof.

Thus, in a case where a reservation is received without confirmation of whether or not a shared car which can travel to a destination designated by a user is ensured, a situation in which there is no usable shared car even when the user travels to the boarding point or the transfer point, or a situation in which there is no usable charger even when the user travels to the facility of a charging point may occur.

The present invention provides a route searching device for a rechargeable vehicle, a route searching method for a rechargeable vehicle, and a program which can provide a facility which is usable on a route to a destination, in accordance with a use state of a facility in a car sharing system in which a plurality of people commonly shares a rechargeable vehicle.

### Solution to Problem

According to a first aspect of the present invention, a route searching device for a rechargeable vehicle includes an acquisition unit and a movement plan creation unit. The acquisition unit acquires facility information regarding a use state of a supply facility which includes at least one of a vehicle supply facility which supplies a rechargeable vehicle, and a charging facility which supplies power to a battery of the rechargeable vehicle. The movement plan creation unit creates a movement plan based on map information and the facility information. The movement plan includes a route to a destination, which includes the supply facility to be used, and supply details received by the supply facility on the route.

According to a twelfth aspect of the present invention, a route searching method for a rechargeable vehicle includes an acquisition step of acquiring facility information regarding a use state of a supply facility which includes at least one of a vehicle supply facility which supplies a rechargeable vehicle, and a charging facility which supplies power to a battery of the rechargeable vehicle, and a movement plan creation step of creating a movement plan based on map information and the facility information, the movement plan including a route to a destination, in which the supply facility to be used is included, and supply details received by the supply facility on the route.

According to a thirteenth aspect of the present invention, a program for causing a computer to execute a process, the process includes an acquisition process of acquiring facility information regarding a use state of a supply facility which includes at least one of a vehicle supply facility which supplies a rechargeable vehicle, and a charging facility which supplies power to a battery of the rechargeable vehicle, and a movement plan creation process of creating a movement plan based on map information and the facility information, the movement plan including a route to a destination, in which the supply facility to be used is included, and supply details received by the supply facility on the route.

### Advantageous Effects of Invention

The route searching device for a rechargeable vehicle, the route searching method for a rechargeable vehicle, and the program can provide a facility usable on a route to a destination, in accordance with a use state of facilities, in a car sharing system in which a plurality of people shares a rechargeable vehicle.

### BRIEF DESCRIPTION OF DRAWINGS

FIG. 1 is a schematic diagram illustrating an example of a rechargeable vehicle management system including a route searching device for a rechargeable vehicle according to an embodiment of the present invention.

FIG. 2 is a block diagram illustrating a configuration example of a route searching device for a rechargeable vehicle (central management server) according to the embodiment of the present invention.

FIG. 3 is a diagram illustrating an example of a dynamic table of an EV car pool according to the embodiment of the present invention.

FIG. 4 is a diagram illustrating an example of a dynamic table of a charging station according to the embodiment of the present invention.

FIG. 5 is a diagram illustrating an example of a dynamic table of reservation information according to the embodiment of the present invention.

FIG. 6 is a diagram illustrating an example of a route obtained by searching of the route searching device for a rechargeable vehicle (central management server) according to the embodiment of the present invention.

FIG. 7 is a flowchart illustrating an example of a route searching method for a rechargeable vehicle according to the embodiment of the present invention.

FIG. 8 is a flowchart illustrating an example of a movement plan creation process included in the route searching method for a rechargeable vehicle, which is illustrated in FIG. 7.

FIG. 9 is a flowchart illustrating an example of a reservation process included in the route searching method for a rechargeable vehicle, which is illustrated in FIG. 7.

FIG. 10 is a flowchart illustrating an example of a reservation monitoring process included in the route searching method for a rechargeable vehicle, which is illustrated in FIG. 7.

FIG. 11 is a diagram illustrating an example of a dynamic table at 14:00.

FIG. 12 is a diagram illustrating an example of a dynamic table at 14:00.

FIG. 13 is a diagram illustrating an example of a dynamic table at 14:00.

FIG. 14 is a diagram illustrating an example of a dynamic table at 15:00.

FIG. 15 is a diagram illustrating an example of a dynamic table at 15:00.

FIG. 16 is a diagram illustrating an example of a dynamic table at 15:00.

### DESCRIPTION OF EMBODIMENTS

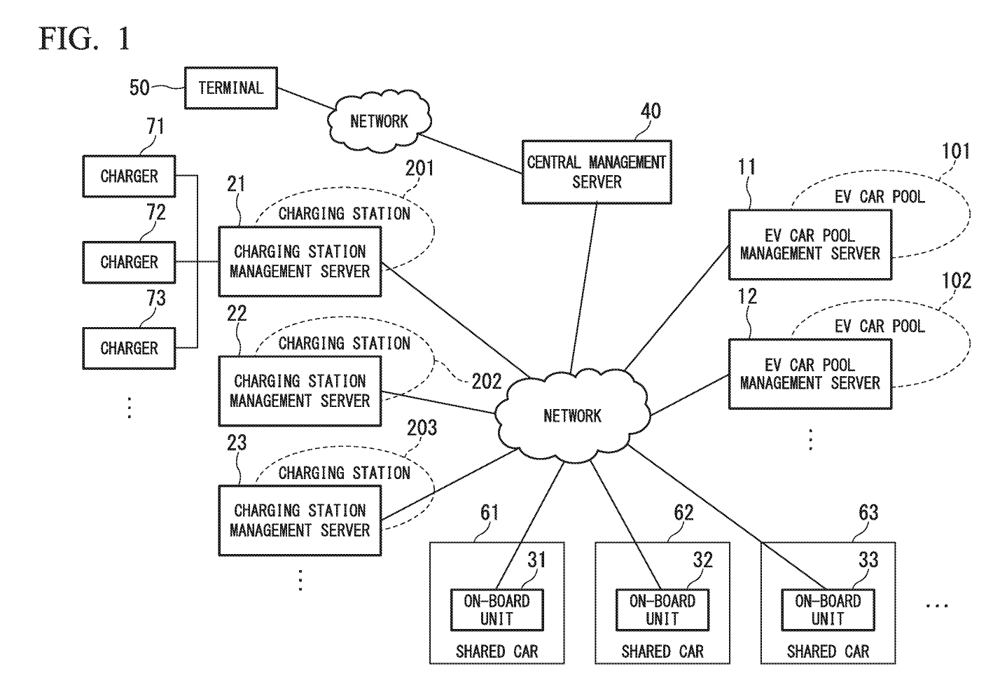

Hereinafter, an example of a rechargeable vehicle management system including a route searching device for a rechargeable vehicle according to an embodiment of the present invention will be described. FIG. 1 is a schematic diagram illustrating an example of a rechargeable vehicle management system including a route searching device for a rechargeable vehicle according to the embodiment of the present invention.

As illustrated in FIG. 1, the rechargeable vehicle management system includes a plurality of EV car pool management servers 11, 12, . . . , a plurality of charging station management servers 21, 22, 23, . . . , a plurality of on-board units 31, 32, 33, . . . , and a central management server 40 which functions as a route searching device for a rechargeable vehicle. The above-described servers and on-board units are connected to each other through a network. The plurality of on-board units 31, 32, 33, . . . is respectively mounted in a plurality of shared cars 61, 62, 63, . . . . Pieces of unique identification information (vehicle ID) which are determined in advance are assigned to the on-board units 31, 32, 33, . . . , or the shared cars 61, 62, 63, . . . .

Each of the plurality of EV car pool management servers 11, 12, . . . is a server that manages facility information regarding a use state of each of EV car pools 101, 102, . . . which are respectively correlated with the EV car pool management servers 11, 12, . . . . The EV car pool corresponds to a facility (vehicle supply facility) in which a shared car for car sharing parks, and a shared car is supplied to a user. A charger which supplies power to a battery of a parking shared car or to a battery attachable to a shared car may be provided in the EV car pool.

The plurality of EV car pool management servers 11, 12, . . . transmits information regarding a use state in an EV car pool to the central management server 40 through the network. For example, each of the plurality of EV car pool management servers 11, 12, . . . transmits information obtained by correlating a vehicle ID with information indicating a battery remaining quantity, a reservation state, and a use state of a shared car parking in each of the EV car pools 101, 102, . . . to the central management server 40. Each of the plurality of EV car pool management servers 11, 12, . . . acquires information indicating a battery remaining quantity, from each of the on-board units 31, 32, 33, . . . of a parking shared car. Each of the plurality of EV car pool management servers 11, 12, . . . may receive information indicating a reservation state or a use state, from a predetermined input unit.

The charging station management server 21 is a server that manages facility information regarding a use state of a charging station 201 in which a plurality of chargers 71, 72, 73, . . . is installed. The charging station 201 corresponds to a facility (charging facility) in which power is supplied to a battery of a shared car for car sharing. The plurality of chargers 71, 72, 73, . . . is installed in the charging station 201. A parking space for parking a shared car in the process of charging is prepared at each of the chargers 71, 72, 73, . . . . Each of the plurality of chargers 71, 72, 73, . . . is a charger that supplies power to a battery of a parking shared car or to a battery attachable to a shared car.

Other charging station management servers 22, 23, . . . are servers that manage facility information regarding use states of the charging stations 202, 203, . . . , similarly to the charging station management server 21. Detailed descriptions thereof will not be repeated.

Each of the plurality of charging station management servers 21, 22, 23, . . . transmits information regarding a use state of a charging station to the central management server 40 through the network. For example, each of the plurality of charging station management servers 21, 22, 23, . . . transmits information obtained by correlating a charger ID with information indicating a reservation state or a use state of a charger installed in each of the charging stations 201, 202, 203, . . . to the central management server 40. Each of the plurality of charging station management servers 21, 22, 23, . . . may receive information indicating a reservation state or a use state, from a predetermined input unit. The charger ID corresponds to unique identification information which is assigned to each charger installed in a charging station, and is determined in advance.

The plurality of on-board units 31, 32, 33, . . . , and the plurality of shared cars 61, 62, 63, . . . in which each of the on-board units is mounted are respectively linked to each other by a vehicle ID. In the embodiment, an example of using an electric car (EV) will be described as an example of a rechargeable vehicle. The embodiment is not limited thereto. The rechargeable vehicle includes a hybrid vehicle.

Each of the plurality of on-board units 31, 32, 33, . . . transmits facility information regarding a use state of a shared car in which an on-board unit is mounted to the central management server 40 through the network. For example, each of the plurality of on-board units 31, 32, 33, . . . acquires information indicating the battery remaining quantity of a shared car, information indicating the current position of the on-board unit which is acquired by using a satellite positioning system, or information indicating a reservation state or a use state of the shared car. Each of the plurality of on-board units 31, 32, 33, . . . transmits information obtained by correlating a vehicle ID with the battery remaining quantity, the current position, the reservation state, or the use state of a shared car to the central management server 40.

The central management server 40 is connected to the EV car pool management servers 11, 12, . . . , the charging station management servers 21, 22, 23, . . . , and a terminal 50 through the network.

The central management server 40 acquires facility information regarding a use state of a supply facility through the network. The supply facility includes at least one of EV car pools at which shared cars are provided, and charging stations at which power is supplied to a battery of a shared car. The central management server 40 searches a route to a destination, and creates a movement plan based on map information and the acquired facility information. The searched route includes a supply facility (EV car pool or charging station) to be used. The movement plan includes the route obtained by searching, and supply details which are received by a supply facility on the route. The supply details received by the supply facility on the route include, for example, information indicating an EV car pool or a charging station used on the route, information indicating a shared car or a charger to be used, a use start time point, a use end time point, information indicating a fare of the EV car pool or the charging station on the route, or information indicating a waiting time for the EV car pool or the charging station used on the route. Details thereof will be described later.

The terminal 50 is a terminal of a user, which is registered in advance in the rechargeable vehicle management system according to the embodiment. The terminal 50 is a portable phone terminal, a smart phone, a tablet terminal, and the like, for example. The terminal 50 includes a touch panel functioning as an input unit and an output unit.

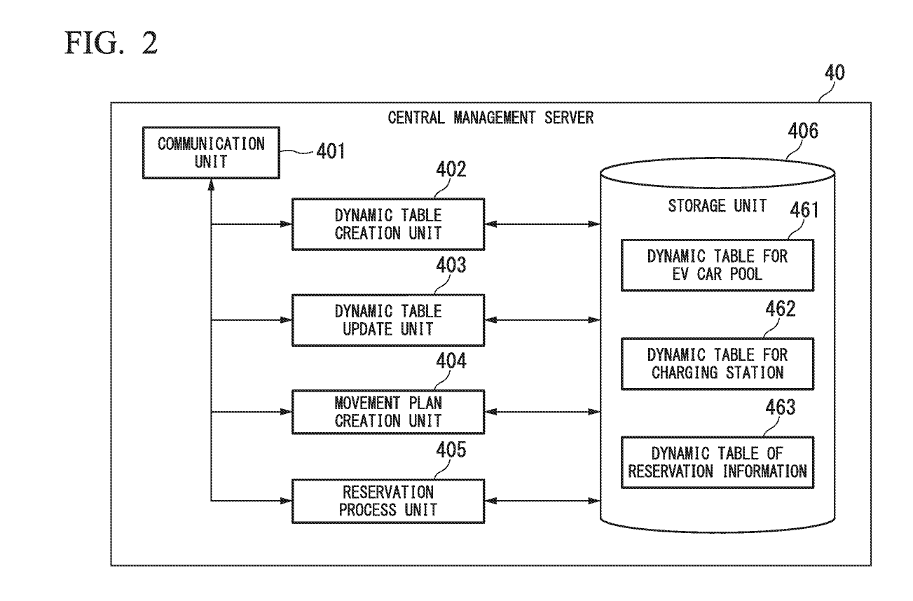

Next, a configuration example of the central management server 40 according to the embodiment will be described with reference to FIG. 2. FIG. 2 is a block diagram illustrating a configuration example of the central management server 40 according to the embodiment.

As illustrated in FIG. 2, the central management server 40 includes a communication unit 401, a dynamic table creation unit 402, a dynamic table update unit 403, a movement plan creation unit 404, a reservation process unit 405, and a storage unit 406.

The communication unit 401 performs transmission and reception of information through the network. The central management server 40 may have a configuration in which an operation unit or an input interface for acquiring information through a connector is included instead of the communication unit 401.

The dynamic table creation unit 402 writes facility information regarding a use state of an EV car pool at which a shared car is provided, in a dynamic table 461 for an EV car pool in the storage unit 406, based on pieces of information received from the plurality of EV car pool management servers 11, 12, . . . , the plurality of charging station management servers 21, 22, 23, . . . , or the plurality of on-board units 31, 32, 33, . . . , thereby creating the dynamic table 461 for an EV car pool.

The dynamic table creation unit 402 writes facility information regarding a use state of a charging station at which power is supplied to a battery of a shared car, in a dynamic table 462 for a charging station in the storage unit 406, based on the pieces of information received from the plurality of EV car pool management servers 11, 12, . . . , the plurality of charging station management servers 21, 22, 23, . . . , or the plurality of on-board units 31, 32, 33, . . . , thereby creating the dynamic table 462 for a charging station.

The dynamic table update unit 403 updates facility information of the dynamic table 461 for an EV car pool, based on an input state of charge of a shared car. The dynamic table update unit 403 updates facility information of the dynamic table 461 for an EV car pool, or facility information of the dynamic table 462 for a charging station, based on details of a reserved movement plan, in a case where the dynamic table 463 of the reservation information is updated.

The movement plan creation unit 404 searches a route to a destination, which includes an EV car pool or a charging station to be used, with reference to the storage unit 406, based on the facility information and the map information. The movement plan creation unit 404 creates a movement plan which includes the route obtained by searching, and supply details received by an EV car pool or a charging station on the searched route.

The movement plan creation unit 404 creates a movement plan which includes an EV car pool at which a shared car having a state of charge which allows traveling to the next EV car pool or the next charging station on the route is ensured, and includes a charging station at which an available charger which is usable by a shared car when the shared car arrives is included, as a supply facility used on the route. Specifically, the movement plan creation unit 404 calculates a consumed power quantity in a case where traveling to the next EV car pool or the next charging station is performed. The movement plan creation unit 404 determines whether or not a shared car having a state of charge which allows power being equal to or greater than the calculated consumed power to be provided is ensured.

The movement plan creation unit 404 creates a movement plan which includes an EV car pool at which the shared car which has traveled is replaced with another shared car, or includes a charging station at which power is supplied to the shared car which has traveled, as the supply facility used on the route.

If a departure point and a destination are designated, the movement plan creation unit 404 selects the optimal movement plan which satisfies a priority condition, among movement plans, for example, based on the priority conditions (shortest time, minimum distance, minimum cost, minimum number of via-places, and the like) which are determined by a user. For example, in a case where it is determined that traveling time has a first priority, as the priority condition, the movement plan creation unit 404 selects a movement plan in which the traveling time is shortest, as the optimal movement plan. For example, in a case where it is determined that a fare has a first priority, as the priority condition, the movement plan creation unit 404 selects a movement plan in which a fare is cheapest, as the optimal movement plan.

The movement plan creation unit 404 may extract optimal routes of a predetermined number or less from routes obtained by searching, based on the priority condition. The movement plan creation unit 404 may create a movement plan based on the extracted routes.

Specifically, in a case where the state of charge of a battery does not allow arrival to an EV car pool at a disembarking point, if a charging point is relayed, a waiting time for charging time occurs. The traveling time is long in a movement plan in which charging is performed at a charging station on the route. However, a fare is cheap in comparison to a case where replacement with another shared car having a large state of charge is performed at an EV car pool on the route. In a case where it is determined that traveling time has a first priority, as the priority condition, the movement plan creation unit 404 selects a route on which replacement with another shared car having a large state of charge is performed at an EV car pool, as the optimal movement plan. For example, in a case where it is determined that a fare has a first priority, as the priority condition, the movement plan creation unit 404 selects a route on which charging is performed at a charging station, as the optimal movement plan.

In a case where a shared car which can travel on a route from a departure point to a destination is not provided at an EV car pool in a boarding point and a transfer point, the movement plan creation unit 404 sets an alternative destination different from the destination, and searches a route on which traveling can be performed with a state of charge of a battery of a shared car in the boarding point. The movement plan creation unit 404 creates a movement plan in which traveling toward the alternative destination obtained by searching is performed.

In a case where details of a movement plan created by the movement plan creation unit 404 are reserved through the terminal 50, the reservation process unit 405 receives a reservation of a shared car based on reservation instruction information, which is received from the terminal 50. The reservation process unit 405 writes the details of the received reservation in the dynamic table 463 of the reservation information in the storage unit 406.

The storage unit 406 stores various types of information required for processing of the central management server 40. The storage unit 406 includes, for example, a dynamic table 461 for an EV car pool, a dynamic table 462 for a charging station, a dynamic table 463 of reservation information, map information, and movement condition information. The map information is information obtained by correlating a position of an EV car pool or a charging station with a map indicating the general geography. The movement condition information is information for calculating moving time, a moving distance, and consumed power in a case where moving on a route obtained by searching is performed.

The storage unit 406 stores information for calculating a fare of a shared car or a charging station, and information for calculating a waiting time for the shared car or the charging station, as the facility information. The information for calculating a fare includes information indicating a fare determined in accordance with a charged power quantity, and a fare determined in accordance with using time of a shared car or a charger. The information for calculating a waiting time includes the charging time determined in accordance with the type or a battery of a charger. The information indicating a reservation state or a use state in the dynamic table may be referred to as information for calculating a waiting time.

The storage unit 406 may be configured on the outside of the central management server 40. In this case, the central management server 40 acquires information stored in the above-described storage unit 406, from an external storage unit.

Next, an example of the dynamic table 461 for an EV car pool will be described with reference to FIG. 3. FIG. 3 is a diagram illustrating an example of the dynamic table 461 for an EV car pool. The dynamic table 461 for an EV car pool is a dynamic table created for each of the plurality of EV car pools 101, 102, . . . . The dynamic table 461 for an EV car pool illustrated in FIG. 3 is a table which stores facility information relating to the use state of the EV car pool 101.

As illustrated in FIG. 3, the dynamic table 461 for an EV car pool is a table in which pieces of information which indicate a vehicle ID, a battery remaining quantity, a reservation state, and a use state are correlated with each other.

The information indicating a vehicle ID is information indicating a vehicle ID of a shared car parking in the EV car pool 101.

The information indicating a battery remaining quantity is information indicating a remaining capacity of the battery of each shared car.

The information indicating a reservation state is information indicating a reservation state of each shared car. The information indicating a reservation state is information indicating a period when a shared car is rented. For example, the information indicating a reservation state includes information indicating a time point when a shared car is rented in a boarding point, and a time point when the shared car is returned in a disembarking point.

The information indicating a use state is information indicating a use state of each shared car. The information indicating a use state is information indicating that a shared car is in a state of being used (that is, a state where the shared car is not in an EV car pool), or in a state of not being used (that is, a state where the shared car stands by in the EV car pool) at the current time point.

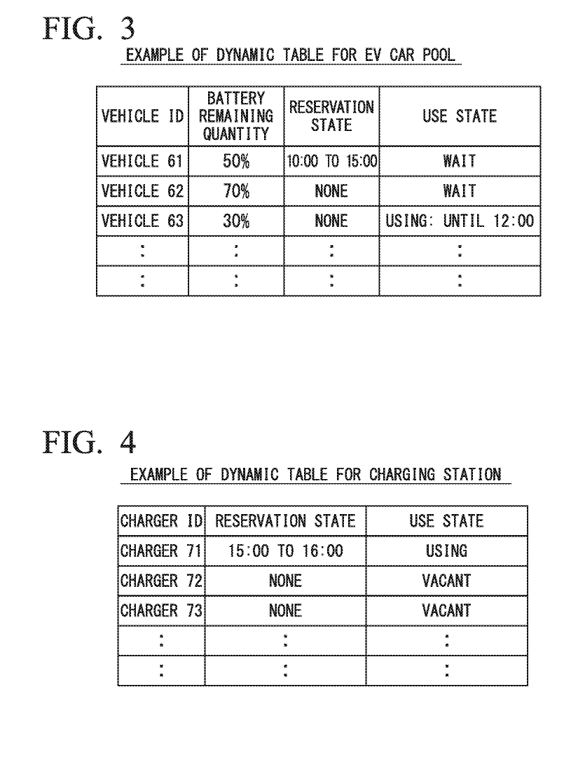

Next, an example of the dynamic table 462 for a charging station will be described with reference to FIG. 4. FIG. 4 is a diagram illustrating an example of the dynamic table 462 for a charging station. The dynamic table 462 for a charging station is a dynamic table created for each of the plurality of charging stations 201, 202, 203, . . . . The dynamic table 462 for a charging station illustrated in FIG. 4 is a table which stores facility information relating to the use state of the charging station 201.

As illustrated in FIG. 4, the dynamic table 462 for a charging station is a table in which pieces of information which indicate a charger ID, a reservation state, and a use state are correlated with each other.

The information indicating a charger ID is information indicating a charger ID of a charger installed in the charging station 201.

The information indicating a reservation state is information indicating a reservation state of a charger. The information indicating a reservation state is information indicating a period when a charger is used. For example, the information indicating a use start time point and a use end time point of a charger.

The information indicating a use state is information indicating a use state of each charger. The information indicating a use state is information indicating whether a charger is being used or is not being used.

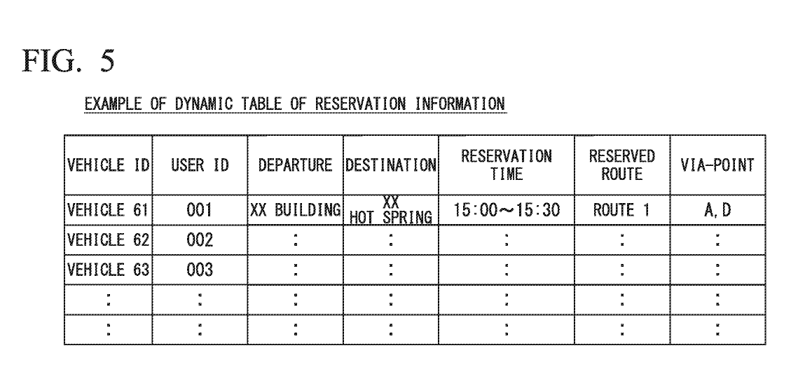

Next, an example of the dynamic table 463 of reservation information will be described with reference to FIG. 5. FIG. 5 is a diagram illustrating an example of the dynamic table 463 of reservation information. The dynamic table 463 of reservation information is a dynamic table created for each reservation, for example, for each user or for each of the plurality of on-board units 31, 32, 33, . . . . The dynamic table 463 of reservation information illustrated in FIG. 5 is a table which stores reservation information regarding the on-board unit 31.

As illustrated in FIG. 5, the dynamic table 463 of reservation information is a table in which pieces of information which indicate a vehicle ID, a user ID, a departure point, a destination, reservation time, a reserved route, a via-point, and a battery remaining quantity are correlated with each other.

The information indicating a vehicle ID is information indicating a vehicle ID of a shared car which is reserved for a use.

The information indicating a user ID is information indicating a user ID of a user who reserves a use.

The information indicating a departure point and the information indicating a destination are pieces of information indicating a departure point and a destination which are reserved by a user.

The information indicating reservation time is information indicating a period when a shared car is rented. For example, the information indicating reservation time includes information indicating a time point when a shared car is rented in a boarding point, and a time point when the shared car is returned in a disembarking point.

The information indicating a reserved route is information indicating a route included in a movement plan which is reserved by a user.

The information indicating a via-point is information indicating a via-point which is included in a route indicated by the reserved route. The via-point includes a charging station at which power is supplied to the battery of the shared car on the route, or an EV car pool at which another shared car is provided on a route for replacing the shared car.

The information indicating a battery remaining quantity is information indicating remaining capacity of the battery of a shared car which is reserved for a use.

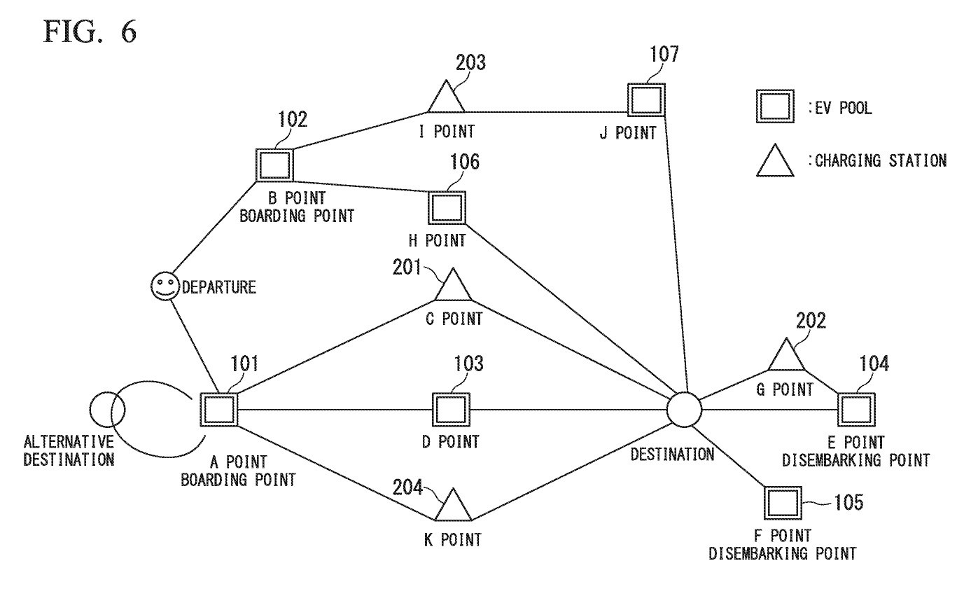

Next, an example of a route obtained by searching of the central management server 40 according to the embodiment will be described with reference to FIG. 6. FIG. 6 is a diagram illustrating an example of a route obtained by searching of the central management server 40 according to the embodiment.

In FIG. 6, quadrangular icons indicate EV car pools and triangular icons indicate charging stations.

Routes 1 and 2 are routes from a departure point to a destination without passing an EV car pool or a charging station, and routes for traveling to a disembarking point by using a shared car in a boarding point.

Route 1:

Departure→EV car pool 101 [A point]→destination→EV car pool 104 [E point]

Route 2:

Departure→EV car pool 101 [A point]→destination→EV car pool 105 [F point]

Routes 3 to 6 are routes from the departure point to the destination through a charging station, and routes in which the battery of a shared car in the boarding point is charged in a via-point and traveling to the disembarking point is performed.

Route 3:

Departure→EV car pool 101 [A point]→destination→charging station 202 [G point]→EV car pool 104 [E point]

Route 4:

Departure→EV car pool 101 [A point]→charging station 201 [C point]→destination→EV car pool 104 [E point]

Route 5:

Departure→EV car pool 101 [A point]→charging station 201 [C point]→destination→EV car pool 105 [F point]

Route 6:

Departure→EV car pool 101 [A point]→charging station 201 [C point]→destination→charging station 202 [G point]→EV car pool 104 [E point]

Routes 7 and 8 are routes from the departure point to the destination through an EV car pool, and routes in which a shared car in the boarding point is replaced in a via-point and traveling to the disembarking point is performed.

Route 7:

Departure→EV car pool 101 [A point]→EV car pool 103 [D point]→destination→EV car pool 104 [E point]

Route 8:

Departure→EV car pool 101 [A point]→EV car pool 103 [D point]→destination→EV car pool 105 [F point]

Route 9 is a route from the departure point to the destination through an EV car pool and a charging station, and is a route in which a shared car in the boarding point is replaced in a via-point, and the battery of the shared car in the boarding point is charged in a via-point.

Route 9:

Departure→EV car pool 101 [A point]→EV car pool 103 [D point]→destination→charging station 202 [G point]→EV car pool 104 [E point]

Routes 10 and 11 are routes from the departure point to the destination through an EV car pool, and routes in which a shared car in the boarding point is replaced in a via-point, and traveling to the disembarking point is performed.

Route 10:

Departure→EV car pool 102 [B point]→EV car pool 106 [H point]→destination→EV car pool 104 [E point]

Route 11:

Departure→EV car pool 102 [B point]→EV car pool 106 [H point]→destination→EV car pool 105 [F point]

Routes 12 to 15 are routes from the departure point to the destination through an EV car pool and a charging station, and routes in which a shared car in the boarding point is replaced in a via-point, the battery of the shared car in the boarding point is charged in a via-point, and traveling to the disembarking point is performed.

Route 12:

Departure→EV car pool 102 [B point]→EV car pool 106 [H point]→destination→charging station 202 [G point]→EV car pool 104 [E point]

Route 13:

Departure→EV car pool 102 [B point]→charging station 203 [I point]→EV car pool 107 [J point]→destination→EV car pool 104 [E point]

Route 14:

Departure→EV car pool 102 [B point]→charging station 203 [I point]→EV car pool 107 [J point]→destination→EV car pool 105[F point]

Route 15:

Departure→EV car pool 102 [B point]→charging station 203 [I point]→EV car pool 107 [J point]→destination→charging station 202 [G point]→EV car pool 104 [E point]

Routes 16 to 18 are routes from the departure point to the destination through a charging station, and routes in which the battery of the shared car in the boarding point is charged in a via-point, and traveling to the disembarking point is performed.

Route 16:

Departure→EV car pool 101 [B point]→charging station 204 [K point]→destination→EV car pool 104 [E point]

Route 17:

Departure→EV car pool 101 [B point]→charging station 204 [K point]→destination→EV car pool 105 [F point]

Route 18:

Departure→EV car pool 101 [B point]→charging station 204 [K point]→destination→charging station 202 [G point]→EV car pool 104 [E point]

Route 19 is a route in which an alternative destination is set, and traveling with a state of charge of the battery of a shared car in the boarding point is allowed, in a case where a shared car which can travel from the departure point to the destination is not provided in the boarding point.

Route 19:

Departure→EV car pool 101 [A point]→alternative destination→EV car pool 101 [A point]

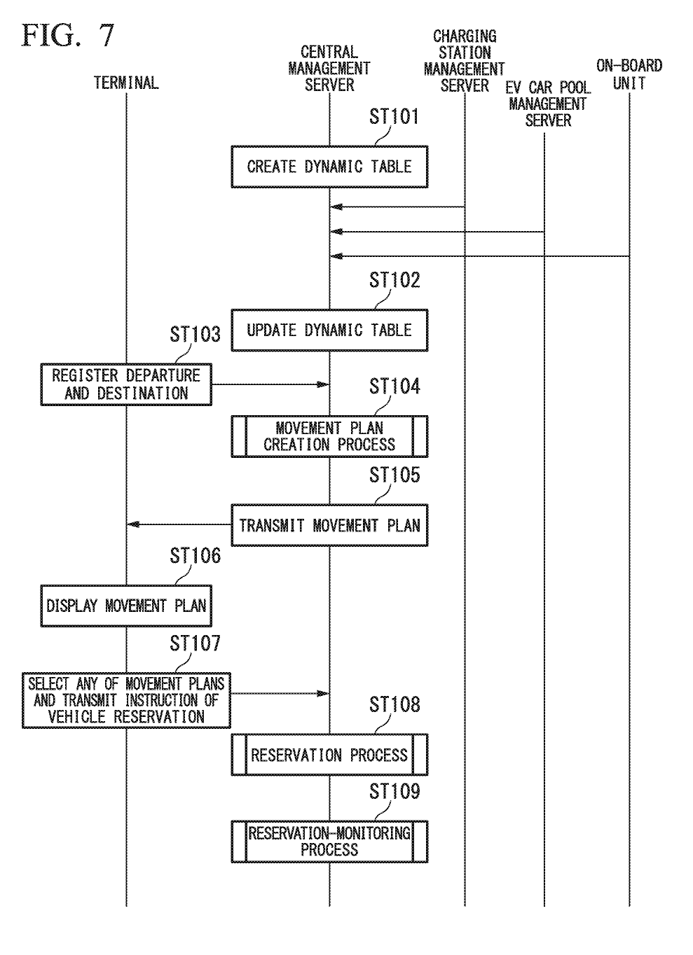

Next, an example of a route searching method for a rechargeable vehicle according to the embodiment will be described with reference to FIG. 7. FIG. 7 is a flowchart illustrating an example of the route searching method for a rechargeable vehicle according to the embodiment.

(Step ST101)

The dynamic table creation unit 402 of the central management server 40 creates the dynamic table 461 for an EV car pool and the dynamic table 462 for a charging station, based on pieces of information received from the plurality of EV car pool management servers 11, 12, . . . , the plurality of charging station management servers 21, 22, 23, . . . , or the plurality of on-board units 31, 32, 33, . . . . The dynamic table creation unit 402 stores the created dynamic table 461 and the created dynamic table 462 in the storage unit 406. The dynamic table creation unit 402 is not limited thereto. In a case where information for calculating a fare of a shared car or a charging station or information for calculating a waiting time for the shared car or the charging station is received as the facility information, the dynamic table creation unit 402 may create a dynamic table for storing these pieces of information in the storage unit 406.

(Step ST102)

The dynamic table update unit 403 of the central management server 40 updates the dynamic table stored in the storage unit 406, at a predetermined timing based on facility information received from the plurality of EV car pool management servers 11, 12, . . . , the plurality of charging station management servers 21, 22, 23, . . . , or the plurality of on-board units 31, 32, 33, . . . . That is, the dynamic table update unit 403 updates, for example, the dynamic table 461 for an EV car pool, and the dynamic table 462 for a charging station. The dynamic table update unit 403 updates each of the dynamic tables, for example, in a case where predetermined time elapses from a time point when each of the dynamic tables is created, or in a case where a predetermined time elapses from the previous update.

(Step ST103)

Then, a user who is a holder of the terminal 50 inputs a departure point and a destination to the terminal 50 for the purpose of reserving a use of a shared car. The terminal 50 transmits information indicating the received departure and destination to the central management server 40. Here, the terminal 50 may receive an estimated departure time point, an estimated arrival time point, a priority condition, or the like, and transmit the received information to the central management server 40. The priority condition is a condition which has a priority in a movement plan. For example, the priority condition is information indicating a rank (priority level) of a condition required to have a priority, among a fare, traveling time, and traveling distance.

(Step ST104)

The movement plan creation unit 404 of the central management server 40 creates a movement plan with reference to the map information and the dynamic table in the storage unit 406, based on the information which is received and indicates the received departure and destination. The created movement plan includes a route to a destination, which includes an EV car pool or a charging station to be used, and includes supply details received by an EV car pool or a charging station on the route. The process will be described later in detail.

(Step ST105)

The communication unit 401 of the central management server 40 transmits information indicating at least one of movement plans created by the movement plan creation unit 404 to the terminal 50.

(Step ST106)

The terminal 50 receives information indicating the movement plans, from the central management server 40, and displays at least one of the movement plans, on the screen.

(Step ST107)

The user selects any one of the displayed movement plans through a touch panel of the terminal 50, and instructs a reservation of a shared car for the selected movement plan.

The terminal 50 receives the reservation of a shared car for the movement plan selected by the user, and transmits information of an instruction of the reservation of a shared car for the selected movement plan to the central management server 40.

(Step ST108)

The reservation process unit 405 of the central management server 40 performs a process of accepting the reservation of a shared car, based on the information received from the terminal 50, and based on the details of the movement plan selected by the user.

(Step ST109)

Then, the movement plan creation unit 404 of the central management server 40 monitors whether or not there is a more suitable route than the route of the accepted reservation. In a case where a change to a more suitable route is performed, a reservation monitoring process of changing reservation details is performed. Details thereof will be described.

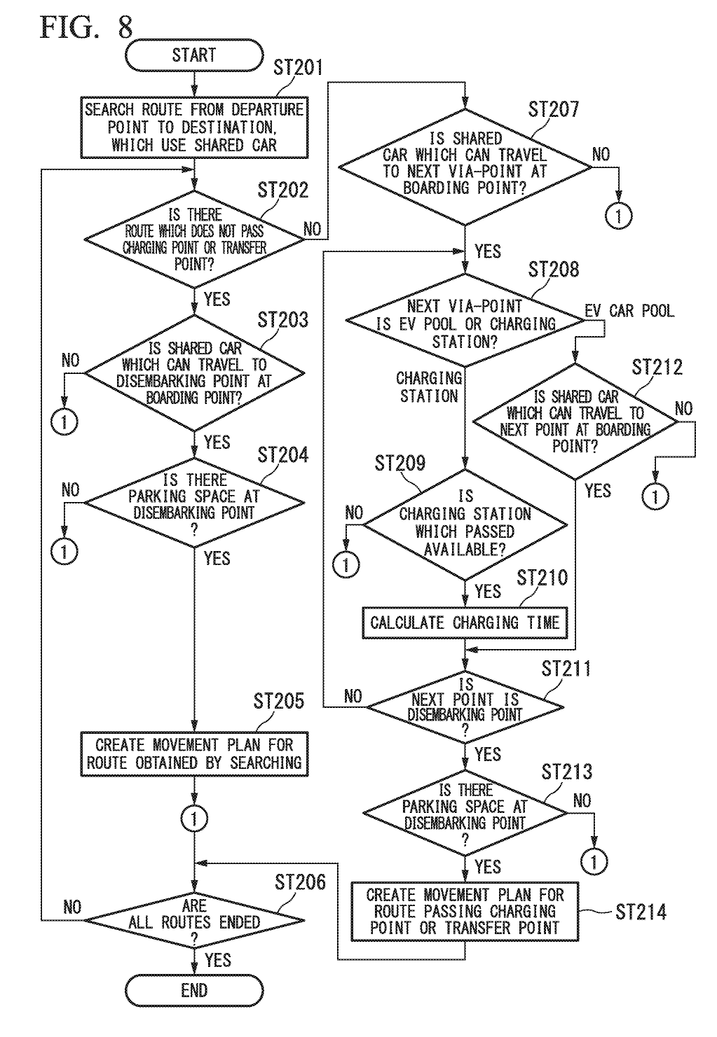

Next, an example of a movement plan creation process included in the route searching method for a rechargeable vehicle, which is illustrated in FIG. 7 will be described with reference to FIG. 8. FIG. 8 is a flowchart illustrating an example of the movement plan creation process included in the route searching method for a rechargeable vehicle, which is illustrated in FIG. 7.

(Step ST201)

The movement plan creation unit 404 searches a route for traveling from a departure point to a destination by using a shared car, with reference to the map information in the storage unit 406, based on the information which is received from the terminal 50, and indicates the departure and the destination.

Specifically, in a case where the departure and the destination are set, the movement plan creation unit 404 searches an EV car pool in a boarding point in a range of a predetermined distance from the departure point, and an EV car pool in a disembarking point in a range of a predetermined distance from the destination, with reference to the map information. The movement plan creation unit 404 searches a route from the EV car pool in the boarding point to the EV car pool at the disembarking point, with reference to the map information. The movement plan creation unit 404 searches an EV car pool or a charging station which is passed on the route. The movement plan creation unit 404 searches a route from the departure point to the destination, a route from the disembarking point to the destination or from the destination to the disembarking point, with reference to the map information.

In this manner, the movement plan creation unit 404 obtains, for example, a plurality of Routes 1 to 18 described in FIG. 6, through the searching.

The movement plan creation unit 404 obtains a moving distance, moving time, and consumed power on each of Routes 1 to 18, with reference to the movement condition information and the facility information in the storage unit 406.

(Step ST202)

The movement plan creation unit 404 selects one route from the Routes 1 to 18 obtained through the searching. The movement plan creation unit 404 determines whether or not the selected route is a route which passes a transfer point (EV car pool) or a charging point (charging station) between the boarding point and the disembarking point.

For example, the movement plan creation unit 404 selects Route 1. In this case, the movement plan creation unit 404 determines that Route 1 is a route which does not pass the transfer point or the charging point, and proceeds to the process of Step ST203.

(Step ST203)

In a case where it is determined that the selected Route 1 is a route which does not pass the transfer point or the charging point, the movement plan creation unit 404 determines whether or not a shared car having a state of charge which allows traveling to the EV car pool 104 [E point] at the disembarking point is included among shared cars ensured at the EV car pool 101 [A point] in the boarding point of Route 1, with reference to the dynamic table 461 for an EV car pool in the storage unit 406. Specifically, the movement plan creation unit 404 determines whether or not a shared car having a state of charge which is equal to or greater than consumption power required when traveling on Route 1 is performed is ensured at the EV car pool in the boarding point.

(Step ST204) In a case where it is determined that the shared car having a state of charge which allows traveling to the EV car pool 104 [E point] at the disembarking point is included among shared cars ensured at the EV car pool 101 [A point] in the boarding point of Route 1, the movement plan creation unit 404 determines whether or not a vacant space which allows parking of a shared car can be ensured at the EV car pool 104 [E point] at the disembarking point of Route 1, at an estimated arrival time point, based on the reservation state of the dynamic table 461 for an EV car pool. The movement plan creation unit 404 obtains a time point, for example, obtained by adding a moving time required when traveling on Route 1 is performed from the current time point, as an estimated arrival time point. The embodiment is not limited to the above descriptions. The movement plan creation unit 404 may obtain a time point obtained by adding the moving time to the estimated departure time point designated by a user, as the estimated arrival time point.

(Step ST205)

In a case where it is determined that a vacant space which allows parking of a shared car can be ensured at the EV car pool 104 [E point] at the disembarking point of Route 1, at the estimated arrival time point, the movement plan creation unit 404 creates a movement plan of Route 1. That is, the movement plan creation unit 404 obtains a fare in a case where Route 1 is used, and creates a movement plan including information. The included information indicates the obtained fare, route details (departure→EV car pool 101 [A point]→destination→EV car pool 104 [E point]) which have already been obtained in Step ST201, a time point at a time of arrival to an EV car pool or a charging station on the route, a moving distance, moving time, and consumed power. The movement plan creation unit 404 creates a movement plan including supply details (for example, a vehicle ID of a shared car to be replaced, a charger ID of a charger for performing charging, and the like), which are received by an EV car pool or a charging station used on Route 1.

(Step ST206)

The movement plan creation unit 404 determines whether or not the determination process of Step ST202 on all routes is ended. In a case where it is determined that the determination process of Step ST202 on all routes is ended, the movement plan creation unit 404 causes the process to proceed to Step ST105 illustrated in FIG. 7.

In a case where it is determined that the determination process of Step ST202 on all routes is not ended, the movement plan creation unit 404 causes the process to return to Step ST202.

(Step ST207)

In Step ST202, the movement plan creation unit 404 selects Route 13, for example. In this case, the movement plan creation unit 404 determines that Route 13 is a route passing a transfer point or a charging point, and proceeds to the process of Step ST207.

In this manner, in a case where it is determined that selected Route 13 is the route passing a transfer point or a charging point, the movement plan creation unit 404 determines whether or not a shared car having a state of charge which allows traveling to the charging station 203 [I point] in the next via-point is included among shared cars ensured at the EV car pool 102 [B point] in the boarding point on Route 13, with reference to the dynamic table 461 for an EV car pool in the storage unit 406. Specifically, the movement plan creation unit 404 obtains consumption power required for traveling to the charging station 203 [I point] from the EV car pool 102 [B point] on Route 13, and determines whether or not a shared car having a battery of a state of charge which is equal to or greater than the obtained consumed power is ensured.

(Step ST208)

In a case where it is determined that a shared car having a state of charge which allows traveling to the next via-point is provided, the movement plan creation unit 404 determines whether the next point is a charging station or an EV car pool.

In a case of Route 13, since the next point of the EV car pool 102 [B point] is the charging station 203 [I point], the movement plan creation unit 404 proceeds to Step ST209.

(Step ST209)

In a case where it is determined that the next point is a charging station, the movement plan creation unit 404 determines whether or not a charger of which a use is not estimated at an estimated time point at which arrival to the charging station is performed is included among chargers installed at the charging station, with reference to the dynamic table 462 for a charging station in the storage unit 406.

(Step ST210)

In a case where it is determined that a charger of which a use is not estimated at an estimated time point at which arrival to the charging station is performed is included among chargers installed at the charging station, the movement plan creation unit 404 calculates time taken for charging power which allows traveling to the next charging station or the next EV car pool from the charging station.

(Step ST211)

Then, the movement plan creation unit 404 determines whether or not the next point is the disembarking point. In a case of Route 13, the EV car pool 107 [J point] is next to the charging station 203 [I point]. Thus, the movement plan creation unit 404 determines the next point is not the disembarking point, and causes the process to return to Step ST208.

Returning to Step ST208, the movement plan creation unit 404 determines that the next point is an EV car pool, and proceeds to Step ST212.

(Step ST212)

Then, the movement plan creation unit 404 determines whether or not a shared car having a state of charge which allows traveling to the next point is included among shared cars ensured at the EV car pool 107 [J point] in the via-point on Route 13, with reference to the dynamic table 461 for an EV car pool in the storage unit 406. Specifically, the movement plan creation unit 404 obtains consumption power required for traveling to the EV car pool 104 [E point] at the disembarking point, from the EV car pool 107 [J point] on Route 13, and determines whether or not a shared car having a state of charge which is equal to or greater than the obtained consumed power is ensured. In a case where it is determined that a shared car having a state of charge which is equal to or greater than the consumed power required for allowing traveling to the next via-point is ensured, the movement plan creation unit 404 proceeds to Step ST211.

(Step ST213)

In Step ST211, in a case where it is determined that the next point is the disembarking point, the movement plan creation unit 404 determines whether or not a vacant space which allows parking of a shared car can be ensured at the EV car pool at the disembarking point of Route 13, at an estimated arrival time point, with reference to the dynamic table 461 for an EV car pool in the storage unit 406. The movement plan creation unit 404 obtains a time point as the estimated arrival time point. The obtained time point is, for example, obtained by adding a moving time required for moving on Route 13 from the current time point, and time taken for charging at the charging station 203 [I point]. The embodiment is not limited to the above descriptions. The movement plan creation unit 404 may obtain a time point obtained by adding the moving time and the charging time to the estimated departure time point designated by a user, as the estimated arrival time point.

(Step ST214)

Then, in a case where it is determined that a vacant space which allows parking of a shared car can be ensured at the EV car pool 104 [E point] at the disembarking point of Route 13, at the estimated arrival time point, the movement plan creation unit 404 creates a movement plan of Route 13. That is, the movement plan creation unit 404 obtains a fare in a case where Route 13 is used, with reference to the dynamic table 461 for an EV car pool in the storage unit 406. The movement plan creation unit 404 creates a movement plan including information. The included information indicates the obtained fare, route details (departure→EV car pool 102 [B point]→charging station 203 [I point]→EV car pool 107 [J point]→destination→EV car pool 104 [E point]) which have already been obtained in Step ST201, a time point at a time of arrival to an EV car pool or a charging station on the route, a moving distance, moving time, and consumed power. The movement plan creation unit 404 creates a movement plan including supply details (for example, a vehicle ID of a shared car to be replaced, a charger ID of a charger for performing charging, and the like), which are received by an EV car pool or a charging station used on Route 1.

In a case where the movement plan creation unit 404 determines to be NO in the processes of Steps ST203, 204, 207, 209, and 212, the movement plan creation unit 404 may calculate a waiting time. For example, in a case where a reservation for using a shared car or a charger at an arrival time point is input, the movement plan creation unit 404 calculates time taken to wait for an end of the reservation. In a case where a shared car having a state of charge which allows traveling to the next point is not provided, the movement plan creation unit 404 calculates a waiting time taken until charging power which allows traveling to the next point is ended.

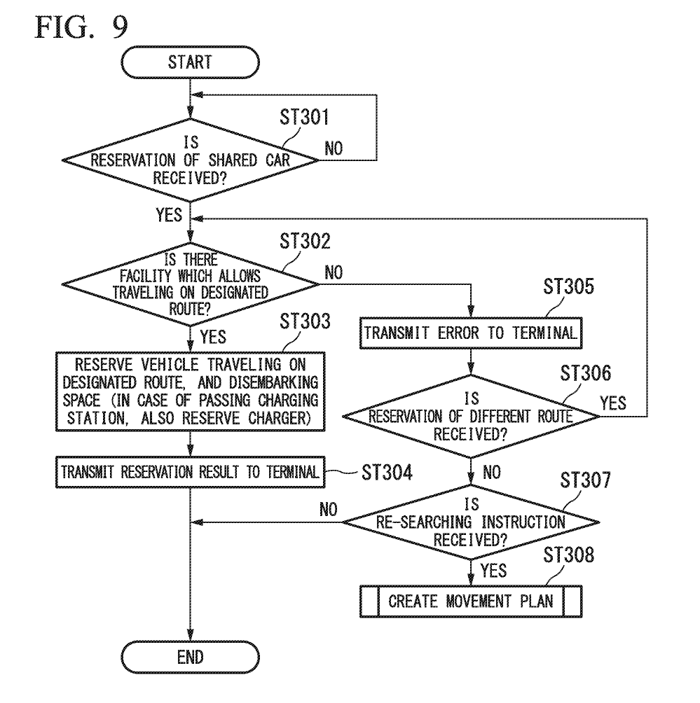

Next, an example of a reservation process included in the route searching method for a rechargeable vehicle, which is illustrated in FIG. 7 will be described with reference to FIG. 9. FIG. 9 is a flowchart illustrating an example of the reservation process included in the route searching method for a rechargeable vehicle, which is illustrated in FIG. 7.

(Step ST301)

The reservation process unit 405 determines whether or not information for an instruction of a reservation of a shared car is received from the terminal 50. The information for an instruction of a reservation of a shared car includes information indicating the movement plan selected by the user.

(Step ST302)

In a case where it is determined that the information for an instruction of a reservation of a shared car is received from the terminal 50, the reservation process unit 405 determines whether or not a facility which allows traveling on the route of the movement plan selected by the user is ensured, based on the received information, with reference to the dynamic table 461 for an EV car pool, and the dynamic table 462 for a charging station. In other words, the reservation process unit 405 determines whether or not a facility of which a use is estimated in the movement plan created by the movement plan creation unit 404 is ensured. This is because there is a probability of creating a movement plan of which a reservation is impossible in a case where a reservation by another user is provided during a period from the creation of the movement plan until the reservation.

For example, it is assumed that the reservation process unit 405 receives information for an instruction of a reservation of a shared car for the movement plan of Route 1. In this case, the reservation process unit 405 determines whether or not a shared car having a state of charge which allows traveling from the EV car pool 101 [A point] in the boarding point to the EV car pool 104 [E point] at the disembarking point is ensured, and a vacant space which allows parking of the shared car at the EV car pool 104 [E point] at the disembarking point can be ensured.

(Step ST303)

In a case where it is determined that a facility which allows traveling on the route of the movement plan selected by the user is ensured, the reservation process unit 405 reserves a shared car traveling on the route of the movement plan selected by the user, and a parking space at the disembarking point.

Here, in a case where the via-point on the route of the movement plan selected by the user includes a charging station, the reservation process unit 405 reserves a charger installed at the charging station in the via-point.

Specifically, the reservation process unit 405 writes a user ID, a vehicle ID of a shared car used in the reserved movement plan, the departure point, the destination, the reservation time, the reserved route, and the via-point which are correlated to each other, in the dynamic table 463 of the reservation information. The user ID is correlated with terminal identification information of the terminal 50 which transmits information for an instruction of the reservation.

(Step ST304)

The reservation process unit 405 transmits information indicating a reservation result to the terminal 50.

(Step ST305)

In Step ST302, in a case where it is determined that a facility which allows the route of the movement plan selected by the user is not ensured, the reservation process unit 405 transmits information indicating an error to the terminal 50 through the communication unit 401. For example, the transmission of information indicating an error corresponds to a case where another user reserves a shared car which has not been reserved at a stage of the movement plan creation process is reserved during a period until the reservation is received.

(Step ST306)

The reservation process unit 405 determines whether or not information for an instruction of a reservation of a shared car in a different movement plan is received from the terminal 50.

In a case where it is determined that the information for an instruction of a reservation of a shared car in a different movement plan is received from the terminal 50, the reservation process unit 405 causes the process to return to Step ST302.

(Step ST307)

In a case where the information for an instruction of a reservation of a shared car for a different movement plan is not received from the terminal 50, the reservation process unit 405 determines whether or not information indicating an instruction of re-searching is received from the terminal 50.

In a case where it is determined that information indicating an instruction of re-searching is not received from the terminal 50, the reservation process unit 405 ends the reservation process.

(Step ST308)

In a case where it is determined that information indicating an instruction of re-searching is received from the terminal 50, the reservation process unit 405 performs the movement plan creation process which is described with reference to FIG. 8.

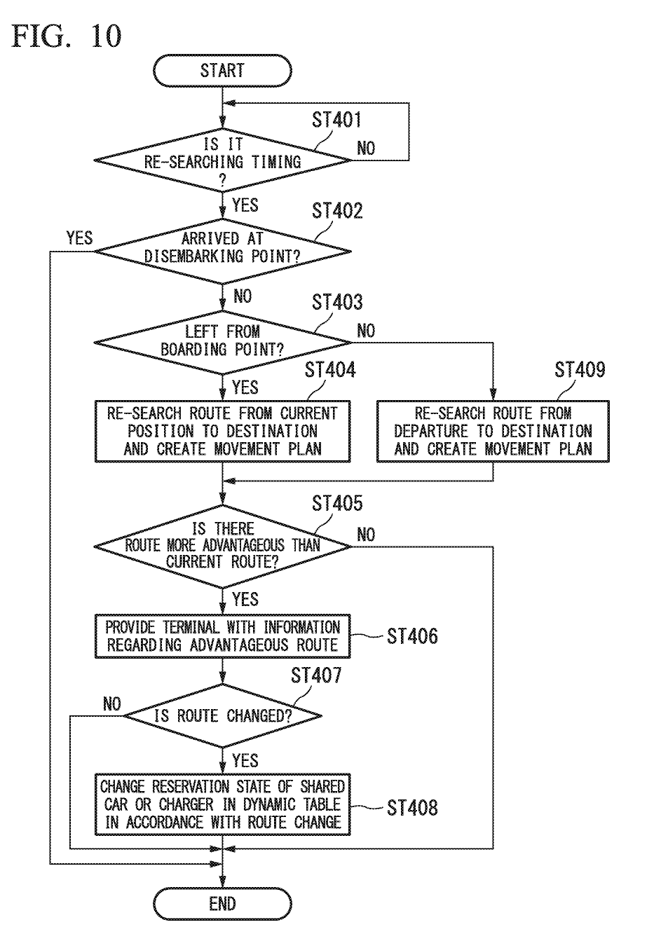

Next, an example of a reservation monitoring process included in the route searching method for a rechargeable vehicle, which is illustrated in FIG. 7, will be described with reference to FIG. 10. FIG. 10 is a flowchart illustrating an example of the reservation monitoring process included in the route searching method for a rechargeable vehicle, which is illustrated in FIG. 7. Here, the reservation monitoring process for the on-board unit 31 which is selected among the plurality of on-board units 31, 32, 33, . . . by the reservation process unit 405 will be described. However, the reservation monitoring process is not limited thereto. The reservation process unit 405 may perform the processes of FIG. 10 for each on-board unit mounted in a reserved shared car.

(Step ST401)

The movement plan creation unit 404 determines whether or not it is a re-searching timing for a route. For example, in a case where it is an update timing of the dynamic table, in a case where predetermined time elapses from when the previous movement plan has been created, or in a case where a traveling shared car changes the route of a movement plan in the middle of being performed, the movement plan creation unit 404 determines that it is a re-searching timing for a route.

Specifically, the movement plan creation unit 404 determines whether or not it is a timing to update the dynamic table 461 for an EV car pool, the dynamic table 462 for a charging station, and the dynamic table 463 of the reservation information. In a case where a predetermined time elapses from a time point when each of the dynamic tables has been created, and in a case where predetermined time elapses from the previous update, the movement plan creation unit 404 determines that it is a timing to update the dynamic tables. In a case where a new reservation is set by the reservation process unit 405, in a case where information is received from the EV car pool management servers 11, 12, . . . , in a case where information is received from the charging station management servers 21, 22, 23, . . . , or in a case where information is received from the on-board units 31, 32, 33, . . . , the movement plan creation unit 404 determines that it is a timing to update the dynamic tables.

The movement plan creation unit 404 determines whether or not the traveling shared car changes the route in the movement plan in the middle of being performed, based on the positional information received from the on-board unit 31, with reference to the dynamic table 463 of the reservation information. In a case where the position of the on-board unit 31 is off the route, the movement plan creation unit 404 determines that the traveling shared car changes the route of the movement plan in the middle of being performed.

(Step ST402)

The movement plan creation unit 404 determines whether or not a shared car 61 arrives an EV car pool at the disembarking point, based on the positional information received from the on-board unit 31, with reference to the dynamic table 461 for an EV car pool and the dynamic table 463 of the reservation information in the storage unit 406.

(Step ST403)

In a case where it is determined that the shared car 61 does not arrive an EV car pool at the disembarking point, the movement plan creation unit 404 determines whether or not the shared car 61 leaves an EV car pool in the boarding point, based on the positional information received from the on-board unit 31, with reference to the dynamic table 461 for an EV car pool and the dynamic table 463 of the reservation information in the storage unit 406.

(Step ST404)

In a case where it is determined that the shared car 61 leaves an EV car pool in the boarding point, the movement plan creation unit 404 searches a route from the current point to the destination, with reference to the dynamic table 463 of the reservation information. The movement plan creation unit 404 performs a movement plan creation process of creating a movement plan of the route obtained by the searching. The movement plan creation process is the same as the process which is described with reference to FIG. 8 except that the departure is changed to the current point.

(Step ST405)

The movement plan creation unit 404 compares the movement plan obtained in Step ST404 with the movement plan which is currently performed, and determines whether or not there is a route of a movement plan which is more advantageous than the movement plan which is currently performed. The movement plan creation unit 404 determines, for example, that a movement plan satisfying the priority condition is an advantageous movement plan based on the priority condition set for each user. For example, in a case where the minimum cost (cheapest fare) is determined as the priority condition, the movement plan creation unit 404 assigns a priority rank having an order of a low fare to movement plans as the priority rank in the priority condition. The movement plan creation unit 404 determines that a movement plan having a highest priority rank is the movement plan satisfying the priority condition. That is, the movement plan creation unit 404 determines that the movement plan having the cheapest fare is an advantageous movement plan. In a case where the movement plan is changed to the movement plan satisfying the priority condition, the movement plan creation unit 404 determines whether or not there is a movement plan having a fare cheaper than the movement plan which is currently performed. For example, the movement plan creation unit 404 compares a fare in a case where the movement plan is changed to the movement plan satisfying the priority condition with the fare of the movement plan which is currently performed. In a case where the fare in a case of being changed is low, the movement plan creation unit 404 determines that the priority rank of the movement plan obtained in Step ST404 is higher than the priority rank of the movement plan which is currently performed. The movement plan creation unit 404 determines that a movement plan which is determined to have a priority rank higher than the priority rank of the movement plan which is currently performed is an advantageous movement plan.

(Step ST406)

In a case where it is determined that the movement plan obtained in Step ST404 is more advantageous than the movement plan which is currently performed, the reservation process unit 405 transmits information regarding the movement plan which is determined to be advantageous to the terminal 50 of the user.

(Step ST407)

The reservation process unit 405 determines whether or not information for an instruction of changing a movement plan to the movement plan determined to be advantageous is received from the terminal 50.

(Step ST408)

In a case where the information for an instruction of changing a movement plan to the movement plan determined to be advantageous is received from the terminal 50, the reservation process unit 405 rewrites reservation information (that is, information regarding the movement plan which is currently performed) which is in the dynamic table 463 of the reservation information and is correlated with the on-board unit 31, based on the movement plan determined to be advantageous.

(Step ST409)

In Step ST403, in a case where it is determined that the shared car 61 does not leave the EV car pool in the boarding point, the movement plan creation unit 404 performs the movement plan creation process. In the movement plan creation process, a route from the departure point to the destination is searched with reference to the dynamic table 463 of the reservation information, and a movement plan of the route obtained by the searching is created. The movement plan creation process is the same as the process which is described with reference to FIG. 8.

The movement plan creation unit 404 proceeds to Step ST405. The movement plan creation unit 404 compares the movement plan obtained in Step ST409 with the movement plan which is currently reserved. The movement plan creation unit 404 determines whether or not a movement plan created after details of the movement plan are reserved is more advantageous than the movement plan which is currently reserved.

In a case where it is determined that the movement plan obtained in Step ST404 is more advantageous than the movement plan which is currently reserved, the reservation process unit 405 proceeds to Step ST406, and transmits information regarding the movement plan which is determined to be advantageous to the terminal 50 of the user.

In a case where the information for an instruction of changing a movement plan to the movement plan determined to be advantageous is received from the terminal 50, the reservation process unit 405 rewrites reservation information (that is, information regarding the movement plan which is currently reserved) which is in the dynamic table 463 of the reservation information and is correlated with the on-board unit 31, based on the movement plan determined to be advantageous.

As described above, the movement plan creation unit 404 of the central management server 40 according to the embodiment can create a movement plan based on the map information and the facility information. The created movement plan includes a route to the destination, which includes an EV car pool or a charging station to be used, and includes supply details received by an EV car pool or a charging station on the route. Thus, the central management server 40 can determine an EV car pool or a charging station to be used on a route to the destination, and can provide the user with the determined route, and supply details received by an EV car pool or a charging station to be used on the route. Accordingly, the user only designates a destination and an arrived point, and can know an EV car pool or a charging station to be used on the route to the destination. Even when reaching the destination with a state of charge of a shared car which is used is impossible, the user can know an EV car pool for replacing another shared car on the route, or a charging station at which the shared car is charged on the route.

The movement plan creation unit 404 of the central management server 40 according to the embodiment creates a movement plan. As the supply facility to be used on the route, the movement plan includes an EV car pool ensuring a shared car having a state of charge which allows traveling to the next EV car pool or the next charging station on the route, or includes a charging station including an available charger which is usable by a shared car when the shared car has arrived. Thus, the central management server 40 can create a movement plan which is movable to the destination without the waiting time, with reference to the dynamic tables.

The movement plan creation unit 404 of the central management server 40 according to the embodiment creates a movement plan. As the supply facility to be used on the route, the movement plan includes an EV car pool at which the shared car which has traveled is replaced with another shared car, or includes a charging station at which power is supplied to the shared car which has traveled. Thus, the central management server 40 can search a supply facility (EV car pool or charging station) which allows smooth transfer or charging, in advance even when transfer or charging is required on the route. Accordingly, it is possible to avoid occurrence of a situation in which a usable shared car is not provided or a situation in which a user waits for using a charger for a long term in a point in which a shared car arrives at a transfer point or a charging point.

The dynamic table update unit 403 of the central management server 40 according to the embodiment can update the dynamic tables based on the terminal, the EV car pool, the charging station, and the information received from the on-board unit. Thus, even when facility information fluctuating by using a shared car is ever-changing, it is possible to apply information in accordance with the latest use state to the dynamic tables. The fluctuating facility information includes, for example, the number of shared cars which are ensured in an EV car pool, and are used, and a usable time zone thereof, a usable charger at a charging station, and a usable time zone thereof, and a state of charge of the shared car.

The central management server 40 according to the embodiment searches a route from the departure point to the destination, with reference to the dynamic tables updated by the dynamic table update unit 403. The central management server 40 creates a movement plan which includes an EV car pool to be used on the route obtained by the searching, and supply details received by the EV car pool. Thus, the movement plan creation unit 404 can create a movement plan in accordance with the latest use state, and can provide the user with the created movement plan.

In a case where a shared car having a state of charge which allows traveling to the destination is not provided at an EV car pool around the departure point, the movement plan creation unit 404 of the central management server 40 according to the embodiment creates a movement plan for allowing traveling to the destination through another EV car pool or another charging station. Thus, even when a shared car which is around the departure point, and can travel to the destination is not provided, it is possible to provide a route in which replacement with another shared car on the route or charging at a charging station on the route is performed. In addition, a shared car replaced on the route or a charging station on the route is reserved in advance, and thus it is possible to assist arrival to the destination as estimated.

In a case where a travel route of the traveling shared car is off the route of the movement plan which is currently performed, the movement plan creation unit 404 of the central management server 40 according to the embodiment creates a new movement plan having a route different from the route of the movement plan which is currently performed. Thus, the movement plan creation unit 404 can provide the user with the optimal movement plan in accordance with the current position of the shared car.

In a case where the movement plan creation unit 404 acquires new facility information, in a case where the dynamic table is updated, or in a case where predetermined time elapses from when the previous creation was performed, that is, when the movement plan was created, the movement plan creation unit 404 creates a new movement plan. Thus, the movement plan creation unit 404 can create a movement plan in accordance with the latest use state, and provide the user with the created movement plan.

In a case where the information of the dynamic table is updated, the movement plan creation unit 404 of the central management server 40 according to the embodiment obtains a route different from the route which is currently performed or currently reserved, by re-searching. In a case where the route obtained by the re-searching is more advantageous than the route which is currently performed or currently reserved the movement plan creation unit 404 receives a change of a movement plan from the user. Thus, even when the number of shared cars which are ensured in an EV car pool, and are used, and the usable time zone thereof, the usable charger at a charging station, and the usable time zone thereof, a state of charge of the shared car, and the like are changed, it is possible to provide the user with a movement plan which is created in accordance with the latest use state, and is advantageous for the user.

The movement plan creation unit 404 of the central management server 40 according to the embodiment selects the optimal movement plan satisfying the priority condition, among a plurality of movement plans, based on the set priority condition. Thus, even when a plurality of movement plans is created, it is possible to provide the user with only a movement plan which is advantageous for the user.

The movement plan creation unit 404 of the central management server 40 according to the embodiment creates a movement plan based on the map information and the facility information. The movement plan includes a moving route between the departure or the current position, and the first EV car pool on the route, and a moving route between the destination and the last EV car pool on the route. For example, the movement plan creation unit 404 creates a movement plan which includes the route from the current position of the user to the first EV car pool, and in which the transportation for traveling on the route is determined. Thus, the user only designates a destination and an arrived point, and can know an EV car pool or a charging station to be used on the route to the destination.

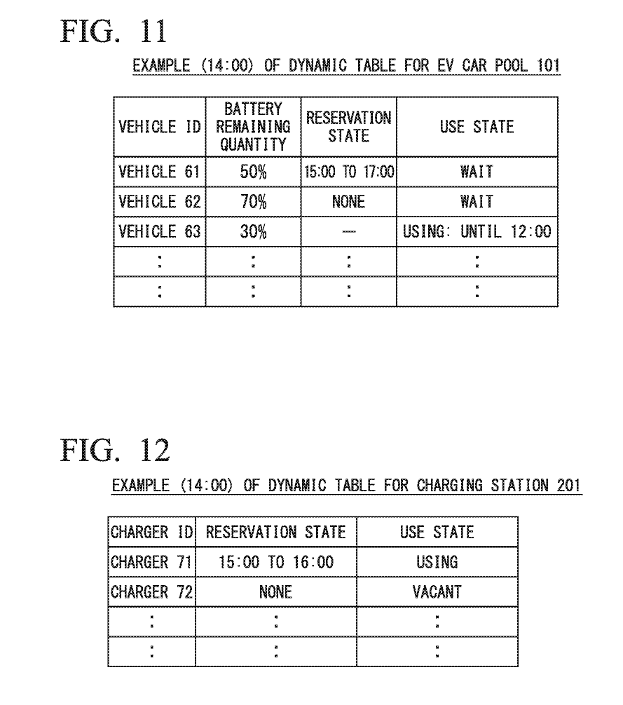

Next, an example of the dynamic table in the central management server 40 according to the embodiment will be described with reference to FIGS. 11 to 16. FIGS. 11 to 13 are diagrams illustrating an example of the dynamic table at 14:00. FIGS. 14 to 16 are diagrams illustrating an example of the dynamic table at 15:00 on the same day.

As illustrated in FIGS. 11 and 14, at the EV car pool 101, a change at 14:00 to 15:00 is as follows.
States of charge of the shared cars 61 and 62 are increased.

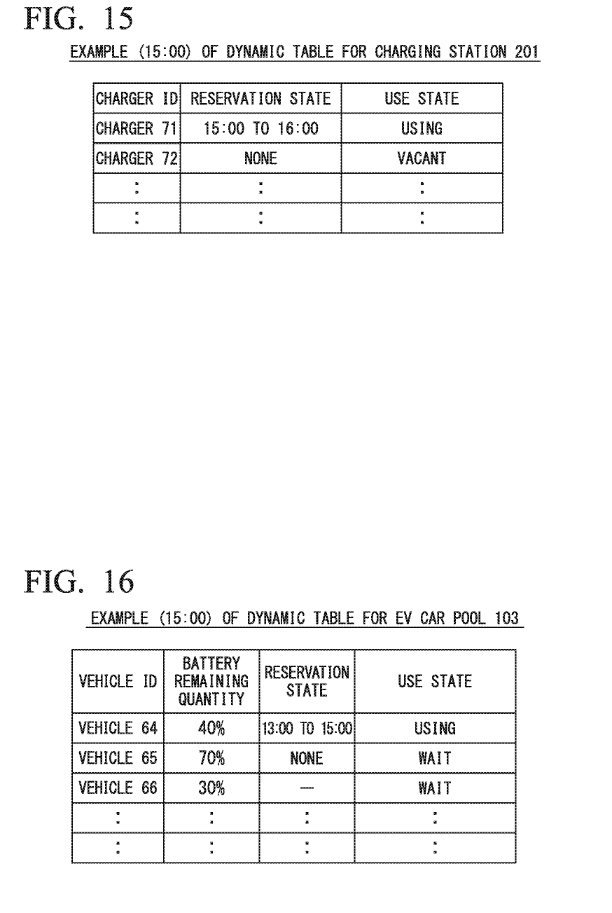

As illustrated in FIGS. 12 and 15, at the charging station 201, a change at 14:00 to 15:00 is not particular.

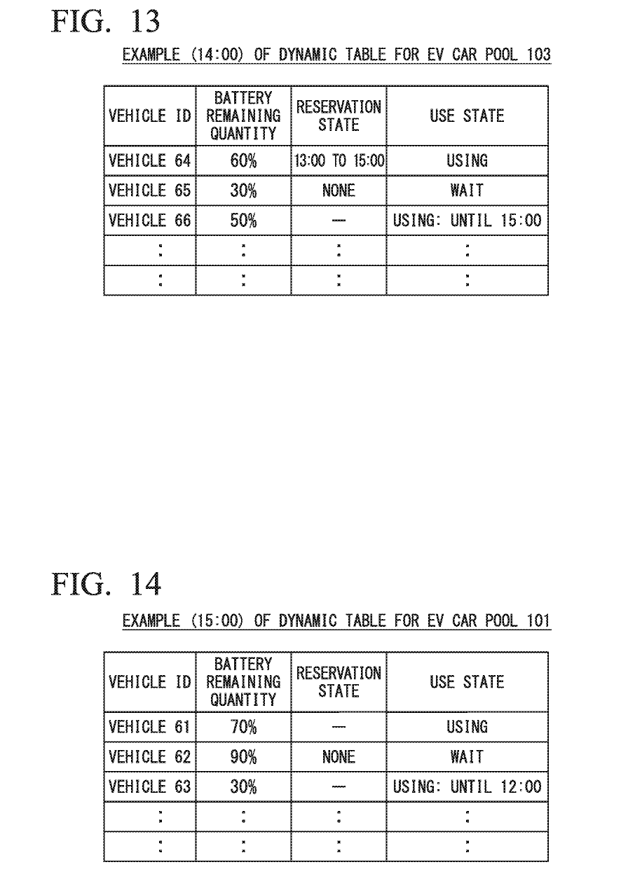

As illustrated in FIGS. 13 and 16, at the EV car pool 103, a change at 14:00 to 15:00 is as follows.
States of charge of the shared cars 64, 65, and 66 are increased.

For example, with reference to FIG. 11, the movement plan creation unit 404 determines that ensuring a shared car having a state of charge which allows traveling to the destination from the EV car pool 101 is impossible. With reference to FIG. 12, in a case where charging is performed on a route from the EV car pool 101 through the charging station 201, the movement plan creation unit 404 determines that traveling to the destination is allowed. In this case, the movement plan creation unit 404 creates a movement plan for Route 4. As described above, Route 4 is a course of departure→EV car pool 101 [A point]→charging station 201 [C point]→destination→EV car pool 104 [E point].

With reference to FIG. 13, in a case where a shared car is replaced on a route from the EV car pool 101 through the EV car pool 103, the movement plan creation unit 404 determines that a shared car which can travel to the destination is not ensured at the EV car pool 103. In this case, the movement plan creation unit 404 does not allow creation of a movement plan for Route 7. As described above, Route 7 is a course of departure→EV car pool 101 [A point]→EV car pool 103 [D point]→destination→EV car pool 104 [E point].

The user considers the movement plan for Route 4 as being reserved. In the movement plan for Route 4, the traveling time is 4 hours.

After that, the state of charge of a shared car at the EV car pool 103 is increased. With reference to FIG. 16, in a case where a shared car is replaced on a route from the EV car pool 101 through the EV car pool 103, the movement plan creation unit 404 determines that a shared car 65 which can travel to the destination is ensured at the EV car pool 103. In this case, the movement plan creation unit 404 creates a movement plan for Route 7. In the movement plan for Route 7, the traveling time is 3.5 hours.

Here, if the movement plan creation unit 404 compares the traveling time in the movement plan for Route 4 with the traveling time in the movement plan for Route 7, the traveling time in the movement plan for Route 7 is shorter than that for Route 4. Thus, the movement plan creation unit 404 determines that not Route 4 but Route 7 is a route of an advantageous movement plan. Accordingly, the movement plan creation unit 404 can provide the user with an advantageous movement plan.

A process in which a program for realizing functions of the central management server 40 in the embodiment is recorded in a computer readable recording medium, and the program recorded in the recording medium is read in a computer system so as to be executed may be performed. Here, the “computer system” is set to include OS or hardware of peripheral devices and the like. The “computer system” is set to include a WWW system which includes a homepage providing environment (or display environment). The “computer readable recording medium” refers to a portable medium such as a flexible disk, a magneto-optic disk, a ROM, and a CD-ROM, and to a storage device such as a hard disk mounted in the computer system. The “computer readable recording medium” is set to include a medium which holds a program for a predetermined period, as with a volatile memory (RAM) in a computer system which functions as a server or a client in a case where a program is transmitted through a network such as the Internet, or through a communication line such as a telecommunication line.

The program may be transmitted from a computer system in which the program is stored in a storage device and the like, through a transmission medium, or the program may be transmitted to other computer systems by using a transmission wave in a transmission medium. Here, the “transmission medium” of transmitting the program refers to a medium having a function of transmitting information, as with a network (communication network) such as the Internet, or a communication line such as a telecommunication line. The program may be used for realizing some of the above-described functions. Further, the program may be a program which can realize the above-described functions by combination with a program which has been already recorded in a computer system, that is, a so-called difference file (difference program).

### INDUSTRIAL APPLICABILITY

The route searching device for a rechargeable vehicle, the route searching method for a rechargeable vehicle, and the program which are described above can provide a facility which is usable on a route to a destination, in accordance with a use state of a facility, in a car sharing system in which people share a rechargeable vehicle.

1. A terminal device for communicating with a route searching device, the terminal device comprising:
a processor configured to:
receive information indicative relating to a supply facility, wherein the supply facility includes at least one of:
a vehicle supply facility for supplying a vehicle; or
a charge supply facility for supplying power to a battery of a vehicle, and
receive information indicative of a first movement plan, wherein the first movement plan includes:
a first route from a first position to a destination, the supply facility is included along the first route, and
supply details related to services available at the supply facility; and
a display unit connecting to the processor, wherein the display unit is configured to display the information indicative of the first movement plan.

2. The terminal device of claim 1, wherein the processor is further configured to receive information indicative of a second movement plan different from the first movement plan, the second movement plan includes:
a second route from a first position to a destination, the supply facility is included along the second route, and
supply details related to services available at the supply facility.

3. The terminal device of claim 2, wherein the display unit includes a touch panel, and the touch panel is configured to receive a selection of the first movement plan or the second movement plan.

4. The terminal device of claim 1, wherein the display unit includes a touch panel, and the touch panel is configured to receive a selection of reservation information related to the supply facility.

5. The terminal device of claim 4, wherein the processor is further configured to generate instructions for transmitting the selection of reservation information to the route searching device.

6. The terminal device of claim 5, wherein the processor is further configured to receive a reservation result in response to the transmitted selection of reservation information.

7. The terminal device of claim 2, wherein the processor is further configured to receive information indicative of whether the second movement plan is advantageous in comparison with the first movement plan.

8. The terminal device of claim 7, wherein the display unit includes a touch panel, and the touch panel is configured to receive a selection for changing from the first movement plan to the second movement plan.

9. The terminal device of claim 8, wherein the processor is further configured to generate instructions for transmitting the selection for changing the first movement plan to the second movement plan.

10. The terminal device of claim 2, wherein the display unit is configured to display the information indicative of the first movement plan and the second movement plant simultaneously.

11. A route searching device for communicating with a terminal device, the route searching device comprising:
a processor configured to:
generate a first movement plan based on a destination, a first position and a supply facility, wherein the supply facility includes at least one of:
a vehicle supply facility for supplying a vehicle; or
a charge supply facility for supplying power to a battery of a vehicle, and
receive reservation instructions from the terminal device, wherein the reservation process unit is further configured to determine availability of a reservation indicated by the received reservation instructions.

12. The route searching device of claim 11, wherein the processor is further configured to generate a second movement plan based on the destination, the first position and the supply facility, and the second movement plan is different from the first movement plan.

13. The route searching device of claim 12, wherein the processor is configured to receive a selection of the first movement plan or the second movement plan from the terminal device.

14. The route searching device of claim 12, wherein the processor unit is configured to transmit information related to whether the second movement plan is advantageous with respect to the first movement plan.

15. The route searching device of claim 11, wherein the processor is configured to generate the first movement plan based on a priority condition received from the terminal device.

16. The route searching device of claim 11, wherein the processor is configured to update a table relating to the supply facility based on the received reservation instructions.

17. The route searching device of claim 11, wherein the processor is further configured to transmit an error to the terminal device in response to a determination that the reservation indicated by the receive reservation instructions is unavailable.

18. The route searching device of claim 11, wherein the processor is further configured to determine availability of a reservation along a second movement plan, different from the first movement plan, in response to instructions from the terminal device to change from the first movement plan to the second movement plan.

19. A terminal device for communicating with a route searching device, the terminal device comprising:
a processor configured to:
receive information indicative relating to a plurality of charge supply facilities for supplying power to a battery of a vehicle, and
receive information indicative of a plurality of movement plans, wherein each movement plan of the plurality of movement plans includes a route from a first position to a destination, and at least one charge supply facility of the plurality of charge supply facilities is included along the route; and
a display unit connecting to the processor, wherein the display unit comprises a touch panel, and the display unit is configured to:
display the information indicative of the plurality of movement plans, and
receive, via the touch panel, a selection of a first movement plan of the plurality of movement plans.

20. The terminal device of claim 19, wherein the processor is further configured to transmit information related to the selection of the first movement plan.

21. The terminal device of claim 19, wherein the touch panel is configured to receive a selection of reservation information related to a first charge supply facility of the plurality of charge supply facilities, and the first charge supply facility is along the route of the first movement plan.

22. The terminal device of claim 21, wherein the processor is further configured to generate instructions for transmitting the selection of reservation information to the route searching device.

23. The terminal device of claim 22, wherein the processor is further configured to receive a reservation result in response to the transmitted selection of reservation information.

24. A non-transitory computer readable medium for storing instructions, wherein a processor executing the instructions is configured to:
receive information indicative relating to a plurality of charge supply facilities for supplying power to a battery of a vehicle
receive information indicative of a plurality of movement plans, wherein each movement plan of the plurality of movement plans includes a route from a first position to a destination, and at least one charge supply facility of the plurality of charge supply facilities is included along the route; and
generate instructions for displaying the information indicative of the plurality of movement plans.

25. The non-transitory computer readable medium of claim 24, further comprising instructions for causing the processor to transmit information related to the selection of the first movement plan to a route searching device separate.

26. The non-transitory computer readable medium of claim 24, further comprising instructions for causing the processor to receive a selection of reservation information related to a first charge supply facility of the plurality of charge supply facilities, wherein the first charge supply facility is along the route of the first movement plan.

27. The non-transitory computer readable medium of claim 26, further comprising instructions for causing the processor to generate instructions for transmitting the selection of reservation information to the route searching device.

28. The non-transitory computer readable medium of claim 25, further comprising instructions for causing the processor to receive a reservation result in response to the transmitted selection of reservation information.

29. The non-transitory computer readable medium of claim 25, further comprising instructions for causing the processor to generate instructions for transmitting updated reservation information in response to selection of a second movement plan of the plurality of movement plans following transmitting of the selection of the first movement plan.

30. The non-transitory computer readable medium of claim 28, further comprising instructions for causing the processor to generate instructions for displaying an error based on a lack of availability of the transmitted selection of reservation information.
